(19) United States
(12) Patent Application Publication
(10) Pub. No.: US 2005/0122253 A1
(43) Pub. Date: Jun. 9, 2005

(54) Electronically tunable phase shifter

(76) Inventor: Dirk Steinbuch, Wimsheim (DE)

Correspondence Address: KENYON & KENYON, ONE BROADWAY, NEW YORK, NY, 10004, US

(21) Appl. No.: 10/956,949

(22) Filed: Oct. 4, 2004

(30) Foreign Application Priority Data
Oct. 13, 2003 (DE) 10347414.5

(51) Int. Cl. G01S 7/40

(52) U.S. Cl. 342/169; 342/171

(57) ABSTRACT

To implement a phase shifter, at least two electronically tunable phase shifter elements are connected in series, pairs of phase shifter elements having opposite phase frequency responses.

### BACKGROUND INFORMATION

The present invention is directed to an electronically tunable phase shifter having at least two electronically tunable phase shifter elements connected in series. A phase shifter is known from “IEEE Transactions on Microwave Theory and Techniques,” Vol. 45, No. 6, June 1997, pp. 963 through 969. The device described therein is a ferroelectric phase shifter using a strip conductor structure.

“The Journal of KMITNB,” Vol. 12, No.1, January-March 2002, pp. 1 through 5 describes a reflection-type varactor-controlled branch line hybrid coupler, which is used as a phase shifter.

### SUMMARY OF THE INVENTION

The electronically tunable phase shifter according to the present invention has pronounced broadband characteristics and operates without distortion. This is achieved by the fact that the pairs of phase shifter elements connected in series have opposite phase frequency responses.

The present invention is based on the following findings:

In high-frequency radar technology, for example, at 24 GHz or 77 GHz, electronic phase shifting is always required. This is required in testing radar systems to reducibly simulate a moving target in which a synthetic Doppler shift corresponding to a phase shift over time is generated. In addition to the HF carrier, a sideband in a frequency range different from the desired Doppler frequency is generated. There are three manners of achieving this goal:

1. A servomotor is used to vary mechanical phase shifters, which rotate a dielectric in a hollow conductor or change the length of a coaxial conductor, for example.

2. After mixing the HF down from 24 GHz, for example, to an easy-to-process frequency of 1 GHz, for example, a sideband is mixed in and then mixed upward to obtain the output frequency.

3. A single-sideband mixer is used to mix a sideband into the high frequency according to the Doppler offset.

In the method according to the present invention, particular value is placed on the broadband characteristic of the phase shifter to ensure a Doppler shift (sideband) also for the radar emitting in the broadband range as is the case of the short-range radar, for example. The most serious disadvantages of the methods presented above are:

1) Mechanical phase shifters are very slow; Doppler frequencies greater than 10 Hz to 30 Hz are not possible. However, at 24 GHz, for example, realistic Doppler frequencies are in the kHz range.

2) Mixing downward and upward is complicated and costly due to the number of components (two mixers, one source), and these systems have an excessively narrow-band characteristic due to the low intermediate frequency.

3) The single-sideband mixer must be triggered by the Doppler frequency. However, the Doppler signal needs to be phase-shifted by 0° and 90° to achieve the extinction of the undesirable sideband. The difficulty here is to achieve the Doppler signal phase shifted by 90°. This is feasible for one frequency, but if a larger range of Doppler frequencies is to be covered, for example, 10 Hz to 10 kHz, it is not possible to achieve the 90° phase shift without excessive complexity.

The triggering effort and the complexity of the HF components are minimal in the case of the phase shifter according to the present invention. Therefore, the phase shifter is well-suited for mass production and field application, because of its compact and reliable design.

One main aspect of the present invention is the generation of the Doppler sideband as in method 1 via a phase shift over time. To generate such sidebands rapidly, in the 10 kHz range, the shift is implemented electronically, rather than mechanically. Triggering is simple, via a single channel, and may be performed using any commercial low-frequency function generator. Furthermore, it is not necessary to mix upward or downward, and little HF is used. To achieve broadband characteristics of 4 GHz, for example, special design measures must be taken.

### BRIEF DESCRIPTION OF THE DRAWINGS

FIG. 1 shows a branch line hybrid coupler as a reflection-type phase shifter element.

FIG. 2 shows a branch line hybrid coupler as a phase shifter element according to FIG. 1 having an alternative transformation network.

FIG. 3 shows the frequency responses of two phase shifter elements having opposite phase frequency responses.

FIG. 4 shows the frequency response of two pairs of phase shifter elements connected in series and having opposite frequency responses.

FIG. 5 shows the layout of a phase shifter having four phase shifter elements connected in series, each pair having opposite frequency responses.

FIG. 6 shows the phase shift of the phase shifter according to the present invention plotted against the trigger voltage.

### DETAILED DESCRIPTION

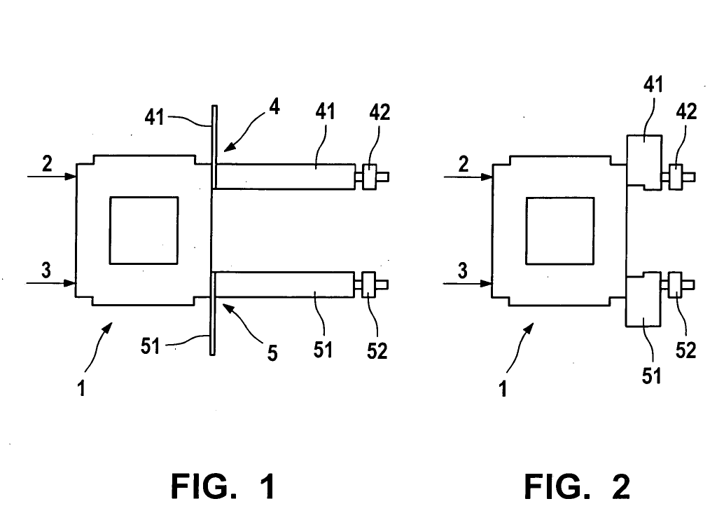

FIG. 1 shows electronically tunable reflection-type phase shifter element 1, which is connected in series with additional phase shifter elements to form a phase shifter according to the present invention. The phase shifter element is used as a transmission element and has a four-port branch line hybrid coupler, two of the four ports 2 and 3 representing the input and output of the phase shifter element, and each additional port 4 and 5 being terminated by grounded varactor diodes 42, 52 via transformation networks 41 and 51. Transformation networks 41, 51 are preferably composed of stub lines and/or line segments for setting different phase run times.

FIG. 2 also shows a phase shifter having a design similar to that of FIG. 1 (type A). Only transformation networks 41 and 51 have a different design here (type B) to achieve opposite phase frequency responses.

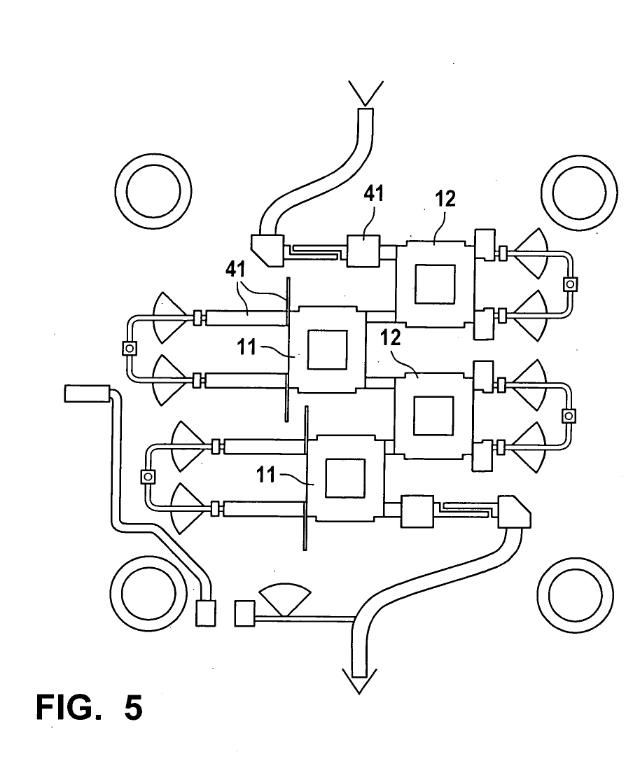

A variable blocking voltage is applied to varactor diodes 42 and 52, changing their capacitance. The supplied high frequency is reflected by varactor diodes 42, 52 and its phase is shifted proportionally to the capacitance of the diodes, because the capacitance affects the phase of the reflection factor. To achieve the desired phase shift, transformation networks 41, 51 are also provided upstream from the diodes. The branch line coupler ensures adaptability to any capacitance state and any transformation network. Because one of these phase shifter elements only achieves a real relative shift of approx. 120°, four of these phase shifter elements 1 or 11 and 12 are connected in series to provide an additional phase reserve in one embodiment according to FIG. 5.

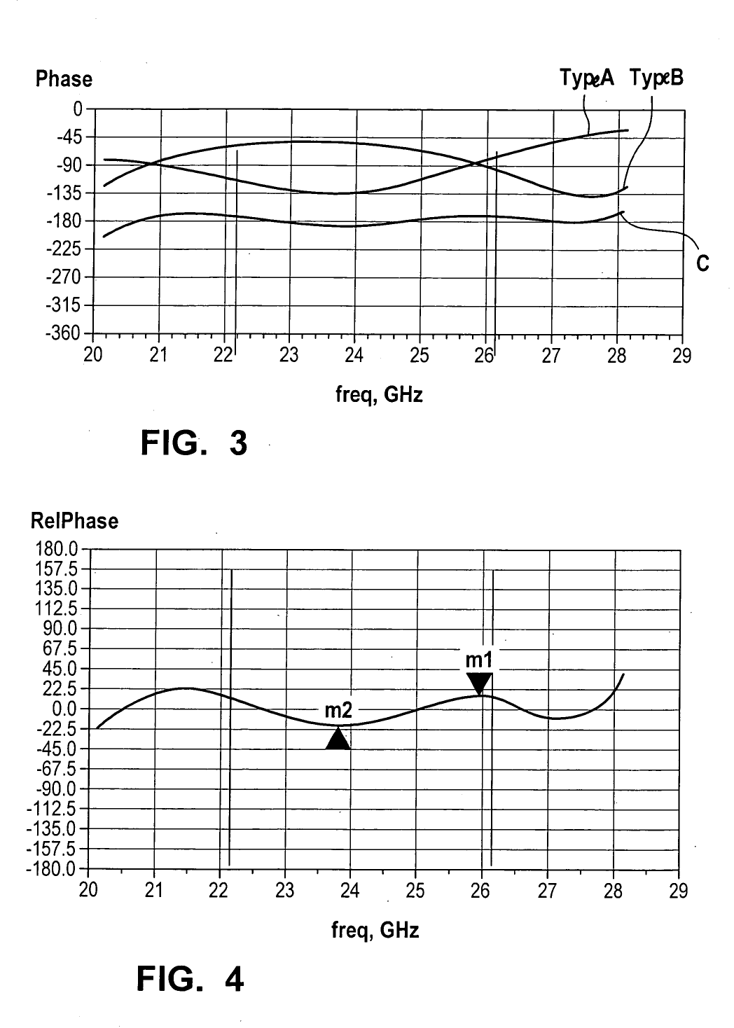

These individual phase shifter elements have a frequency response which yields narrow-band phase variation over the frequency. A shift of up to 45° at the band boundaries is achieved via 4 GHz and 90° phase. At 360° shifts of up to 180° would be achieved at the band boundaries. For a broadband system such as short-range radar, this group runtime effect would result in the transmitted pulse being totally distorted and rounded. This problem is solved by pairing phase shifter elements having different, in particular opposite, phase characteristics over the frequency. While type A (FIG. 3) has a shift of −45° at the band boundaries, type B has a +45° shift. Connecting both types in series results in a considerably flatter phase curve (FIG. 3, curve C).

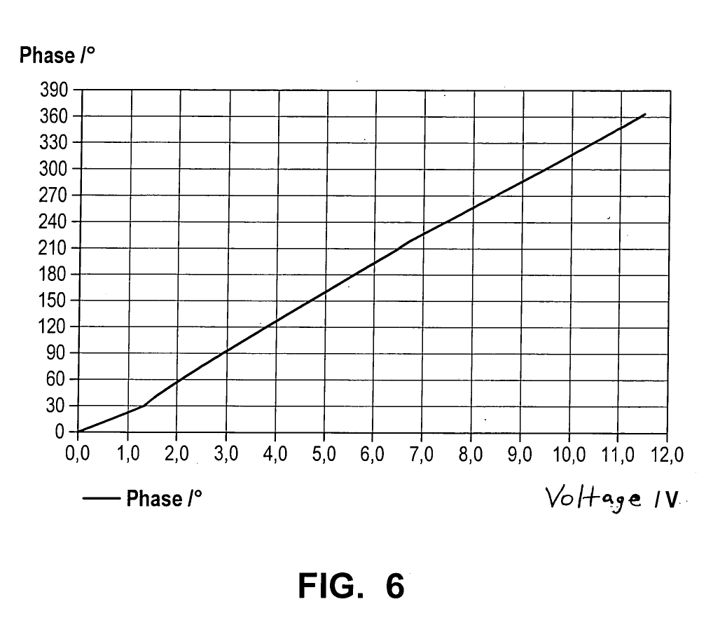

Using varactor diodes having hyper-abrupt doping, for example, M/A-COM MA4H120, achieves very good linearity, such as the phase shift plotted against the triggering voltage shown in FIG. 6. This linearity is important for achieving little distortion of the generated Doppler shift, i.e., free of higher harmonics.

The phase shift of the complete phase shifter, for example, according to FIG. 5, including two phase shifter elements A having reference numeral 11 and two phase shifter elements B having reference numeral 12 in series is shown in FIG. 4. The phase difference at m, is 13.924°, and at m₂ it is −31.83°.

1. A phase shifter comprising:
at least two tunable electronic phase shifter elements connected in series, the at least two phase shifter elements including pairs of phase shifter elements connected in series having opposite phase frequency responses.

2. The phase shifter according to claim 1, wherein the phase shifter is of a reflection type.

3. The phase shifter according to claim 1, further comprising voltage-controlled varactors, each of the phase shifter elements including a four-port branch line hybrid coupler, two of the four ports being connected to the varactors and the other ports representing an input and an output of the phase shifter element.

4. The phase shifter according to claim 3, wherein the varactors include varactor diodes having hyper-abrupt doping.

5. The phase shifter according to claim 3, further comprising transformation networks situated between the varactors and corresponding ports of the branch line hybrid coupler.

6. The phase shifter according to claim 5, wherein the opposite phase frequency responses of the phase shifter elements are achieved via different ones of the transformation networks.

7. The phase shifter according to claim 1, wherein the phase shifter is for generating a synthetic Doppler shift, generating a phase shift over time.

8. The phase shifter according to claim 7, wherein the phase shifter is for simulating a moving target in broadband radar applications.
